(19) United States
(12) Patent Application Publication
(10) Pub. No.: US 2010/0244306 A1
(43) Pub. Date: Sep. 30, 2010

(54) ASYMMETRIC GAS SEPARATION MEMBRANES WITH SUPERIOR CAPABILITIES FOR GAS SEPARATION

(75) Inventor: Man-Wing Tang, Cerritos, CA (US)

Correspondence Address: HONEYWELL/UOP;PATENT SERVICES, 101 COLUMBIA DRIVE, P O BOX 2245 MAIL STOP AB/2B, MORRISTOWN, NJ, 07962, US

(73) Assignee: UOP LLC, Des Plaines, IL (US)

(21) Appl. No.: 12/797,220

(22) Filed: Jun. 9, 2010

Related U.S. Application Data
(63) Continuation-in-part of application No. 11/612,412, filed on Dec. 18, 2006.

(51) Int. Cl. B29C 39/14

(52) U.S. Cl. 264/165

(57) ABSTRACT

This invention relates to a method of making flat sheet asymmetric membranes, including cellulose diacetate/cellulose triacetate blended membranes, polyimide membranes, and polyimide/polyethersulfone blended membranes by formulating the polymer or the blended polymers dopes in a dual solvent mixture containing 1,3 dioxolane and a second solvent, such as N,N′-methylpyrrolidinone (NMP). The dopes are tailored to be closed to the point of phase separation with or without suitable non-solvent additives such as methanol, acetone, decane or a mixture of these non-solvents. The flat sheet asymmetric membranes are cast by the phase inversion processes using water as the coagulation bath and annealing bath. The dried membranes are coated with UV curable silicone rubber. The resulting asymmetric membranes having a skin thickness of less than 100 nm, exhibit excellent permeability and selectivity compared to the intrinsic dense film performances.

### CROSS-REFERENCE TO RELATED APPLICATION

This application is a Continuation-In-Part of copending application Ser. No. 11/612,412 filed Dec. 18, 2006, the contents of which are hereby incorporated by reference in its entirety.

### FIELD OF THE INVENTION

This invention relates to a process of manufacturing asymmetric gas separation membranes. More particularly, this invention relates to the use of a solvent mixture that allows for manufacture of asymmetric gas separation membranes with improved properties.

### BACKGROUND OF THE INVENTION

Polymeric gas-separation asymmetric membranes are well known and are used in such areas as production of oxygen-enriched air, nitrogen-enriched streams for blanketing fuels and petrochemicals, separation of carbon dioxide from methane in natural gas, hydrogen recovery from ammonia plant purge streams and removal of organic vapor from air or nitrogen.

Semipermeable asymmetric cellulosic “skinned” separation membranes formed by phase inversion and solvent exchange methods are known (see U.S. Pat. No. 3,133,132) which is hereby incorporated by reference). Such membranes are characterized by a thin, dense, selectively semipermeable surface “skin” and a less dense void-containing, non-selective support region, with pore sizes ranging from large in the support region to very small proximate to the “skin”.

As is well known to those skilled in the art, the ideal gas-separation membrane would combine high selectivity with high flux. There are three key parameters that determine the commercial viability of a membrane for gas separation. The first is the membrane's separation factor towards the gas pair to be separated. The second parameter is the membrane permeation flux which dictates the membrane area requirement. The higher the permeation flux, the smaller the membrane area required. The third parameter is the working life of membrane. Commercially available asymmetric flat sheet gas separation membranes containing cellulose diacetate and cellulose triacetate are made from casting a dope containing a solvent mixture of 1,4 dioxane, and N-methylpyrrolidone together with one or two suitable non-solvents. Similarly, asymmetric membranes also have been made from polyimides such Matrimid® which is the condensation product of 3,3′,4,4′-benzophenone tetra-carboxylic dianhydride and 5(6)-amino-1-(4′-aminophenyl)-1,3,3′-trimethylindane from Ciba-Giegy Corporation, or Victrex® a Polyethersulfone 6010 manufactured by BASF Corporation or a blended polymer dope containing 1,4 dioxane, or NMP, N,N′-dimethylacetamide, dimethylformamide or the mixtures of these solvents. In prior art processes, 1,4 Dioxane was found to be needed in the casting dope to form the extremely thin integral dense skin on top of the resulting asymmetric membrane. Without the use of 1,4 Dioxane, the result was either an opened membrane (an ultra filtration membrane) or a very dense membrane would result from the process. In either case, the membrane would be unsuited for gas separations. For the same reason, because the polyimide polymer sold under the trade name P84 from HP Polymer GmbH and Ultem from General Electric does not dissolve in 1,4 dioxane asymmetric membranes can only be made from the NMP casting dope unless the temperature of dope is raised to about 100° C. prior to the phase inversion process.

O'Neill et al (U.S. Pat. No. 6,187,248) teaches a method of producing a film with 1,3-dioxolane with average pore size in the range of <30 nm and the film has a thickness of 2-10 microns. In the present invention, the estimated (back calculated from the intrinsic dense film measurement and the permeance of the asymmetric membrane we claim) total skin thickness of the asymmetric membrane is only approximately 30 to 35 nm which is 60 times thinner than O'Neill's teaching and more importantly, indicating O'Neill teaches making a symmetric film (not asymmetric membrane) with uniform pore size of <30 nm. O'Neill does not make any separation claims at all because the average pore size is too large for gas separation applications. In view of O'Neill's teaching one would avoid using a 1,3-dioxolane and NMP system to make asymmetric membrane.

Other prior art references have either not disclosed a gas separation membrane or have not realized the advantages of using the particular solvent system that has now been found advantageous in the preparation of asymmetric membranes having the skin thickness and selectivity for gas separation as the asymmetric membranes of the present invention.

### SUMMARY OF THE INVENTION

In the present invention we have discovered that the use of a 1,3 dioxolane solvent for the polymer or the polymer blend dope provides integrally skinned asymmetric membranes with superior permeation flux and selectivity. This solvent has a boiling point of 75° C., forms very stable homogeneous solutions with cellulose diacetate/cellulose triacetate blended polymer, Matrimid polyimide, Ultem polyetherimide, P84 and P84HT polyimide polymers respectively and it is 100% miscible with water. Cellulose diacetate/triacetate blended asymmetric membranes, Matrimid polyimide asymmetric membranes, Matrimid/Polyethersulfone asymmetric blended membranes and P84/Polyethersulfone asymmetric blended membranes have been successfully made with a casting dope containing 1,3 dioxolane and NMP solvents in 2:1 ratio and water as the coagulation bath. The polymers become the continuous polymer matrix in the membrane.

Some preferred polymers that can be used as the continuous blend polymer matrix include, but are not limited to, cellulosic polymers such as cellulose acetate, cellulose triacetate, cellulose acetate butyrate, cellulose acetate propionate, polysulfones, sulfonated polysulfones, polyethersulfones (PESs), sulfonated PESs, polyethers, polyetherimides such as Ultem (or Ultem 1000) sold under the trademark Ultem®, manufactured by GE Plastics, and available from GE Polymerland, and polyamides; polyimides such as Matrimid sold under the trademark Matrimid® by Huntsman Advanced Materials (Matrimid® 5218 refers to a particular polyimide polymer sold under the trademark Matrimid®) and P84 or P84HT sold under the tradename P84 and P84HT respectively from HP Polymers GmbH; polyamide/imides; polyketones, polyether ketones; and microporous polymers.

The non-solvents may include methanol, ethanol, isopropanol, acetone, methylethylketone, lactic acid, maleic acid, malic acid, decane, dodecane, nonane, and octane with a mixture of methanol and acetone, decane, lactic acid being preferred.

The method of the invention comprises first dissolving at least one polymer miscible polymers in 1,3 dioxolane/NMP solvents by mechanical stirring to form a homogeneous casting dope; then quenching the casting dope into a cold water gelation bath (typically at a temperature in the range of about 0° C. to about 25° C., preferably from about 0° C. to 5° C.) supported by an appropriate support such as a woven or non-woven fabric, silicone coated paper or a film, such as Mylar® polyester film; densifying the skin of the asymmetric membrane in a second water bath at a higher temperature between about 25° and about 100° C. (preferably from about 80° to about 86° C.); then removing the water from the membrane at a drying temperature that can range from about 20° to 150° C. (preferably from about 65° to 70° C.) and finishing by coating the surface of the asymmetric membrane with a thermally curable or UV curable polysiloxane or other suitable coating.

The membranes of the invention comprise a porous asymmetric membrane layer having a skin thickness of less than about 100 nm, preferably less than about 30 to 60 nm and most preferably between about 30 and 35 nm. These porous asymmetric membrane layers have a selectivity of at least 5 for separation of mixtures of CO₂/CH₄ at 50° C. and preferably a selectivity of at least 20 at 50° C.

### DETAILED DESCRIPTION OF THE INVENTION

In the present invention we have discovered that the use of a 1,3 dioxolane solvent for the polymer or the polymer blend dope provides integrally skinned asymmetric membranes with superior permeation flux and selectivity. This solvent has a boiling point of 75° C., forms very stable homogeneous solutions with cellulose diacetate/cellulose triacetate blended polymer, Matrimid polyimide, Ultem polyetherimide, P84 and P84HT polyimide polymers respectively and it is 100% miscible with water. Cellulose diacetate/triacetate blended asymmetric membranes, Matrimid polyimide asymmetric membranes, Matrimid/Polyethersulfone asymmetric blended membranes and P84/Polyethersulfone asymmetric blended membranes have been successfully made with a casting dope containing 1,3 dioxolane and NMP solvents in 2:1 ratio and water as the coagulation bath. The polymers become the continuous polymer matrix in the membrane.

Typical polymers suitable for membrane preparation as the continuous polymer matrix can be selected from, but are not limited to, polysulfones; sulfonated polysulfones; polyethersulfones (PESs); sulfonated PESs; polyethers; polyetherimides such as Ultem (or Ultem 1000) sold under the trademark Ultem®, manufactured by GE Plastics, poly(styrenes), including styrene-containing copolymers such as acrylonitrilestyrene copolymers, styrene-butadiene copolymers and styrene-vinylbenzylhalide copolymers; polycarbonates; cellulosic polymers, such as cellulose acetate, cellulose triacetate, cellulose acetate-butyrate, cellulose propionate, ethyl cellulose, methyl cellulose, nitrocellulose; polyamides; polyimides such as Matrimid sold under the trademark Matrimid® by Huntsman Advanced Materials (Matrimid® 5218 refers to a particular polyimide polymer sold under the trademark Matrimid®) and P84 or P84HT sold under the tradename P84 and P84HT respectively from HP Polymers GmbH; polyamide/imides; polyketones, polyether ketones; poly(arylene oxides) such as poly(phenylene oxide) and poly(xylene oxide); poly(esteramide-diisocyanate); polyurethanes; polyesters (including polyarylates), such as poly(ethylene terephthalate), poly(alkyl methacrylates), poly(acrylates), poly(phenylene terephthalate), etc.; polysulfides; polymers from monomers having alpha-olefinic unsaturation other than mentioned above such as poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl esters) such as poly(vinyl acetate) and poly(vinyl propionate), poly(vinyl pyridines), poly(vinyl pyrrolidones), poly(vinyl ethers), poly(vinyl ketones), poly(vinyl aldehydes) such as poly(vinyl formal) and poly(vinyl butyral), poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly (benzimidazole); polycarbodiimides; polyphosphazines; microporous polymers; and interpolymers, including block interpolymers containing repeating units from the above such as terpolymers of acrylonitrile-vinyl bromide-sodium salt of para-sulfophenylmethallyl ethers; and grafts and blends containing any of the foregoing. Typical substituents providing substituted polymers include halogens such as fluorine, chlorine and bromine; hydroxyl groups; lower alkyl groups; lower alkoxy groups; monocyclic aryl; lower acryl groups and the like.

Some preferred polymers as the continuous blend polymer matrix include, but are not limited to, polysulfones, sulfonated polysulfones, polyethersulfones (PESs), sulfonated PESs, polyethers, polyetherimides such as Ultem (or Ultem 1000) cellulosic polymers such as cellulose acetate and cellulose triacetate, polyamides; polyimides such as Matrimid, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediamine] (poly(6FDA-m-PDA)), poly[2,2′-bis-(3,4-dicarboxyphenyl)hexafluoropropane dianhydride-1,3-phenylenediamine-3,5-diaminobenzoic acid)] (poly(6FDA-m-PDA-DABA)), P84 or P84HT; polyamide/imides; polyketones, and polyether ketones.

Some more preferred polymers that can be used as the continuous blend polymer matrix include, but are not limited to, cellulosic polymers such as cellulose acetate, cellulose triacetate, cellulose acetate butyrate, cellulose acetate propionate, polysulfones, sulfonated polysulfones, polyethersulfones (PESs), sulfonated PESs, polyethers, polyetherimides such as Ultem (or Ultem 1000) sold under the trademark Ultem®, manufactured by GE Plastics, and available from GE Polymerland, and polyamides; polyimides such as Matrimid sold under the trademark Matrimid® by Huntsman Advanced Materials (Matrimid® 5218 refers to a particular polyimide polymer sold under the trademark Matrimid®) and P84 or P84HT sold under the tradename P84 and P84HT respectively from HP Polymers GmbH; polyamide/imides; polyketones, polyether ketones; and microporous polymers.

The non-solvents may include methanol, ethanol, isopropanol, acetone, methylethylketone, lactic acid, maleic acid, malic acid, decane, dodecane, nonane, and octane with a mixture of methanol and acetone, decane, lactic acid being preferred.

The method of the invention comprises first dissolving at least one polymer miscible polymers in 1,3 dioxolane/NMP solvents by mechanical stirring to form a homogeneous casting dope; then quenching the casting dope into a cold water gelation bath (typically at a temperature in the range of about 0° C. to about 25° C., preferably from about 0° C. to 5° C.) supported by an appropriate support such as a woven or non-woven fabric, silicone coated paper or a film, such as Mylar® polyester film; densifying the skin of the asymmetric membrane in a second water bath at a higher temperature between about 25° and about 100° C. (preferably from about 80° to about 86° C.); then removing the water from the membrane at a drying temperature that can range from about 20° to 150° C. (preferably from about 65° to 70° C.) and finishing by coating the surface of the asymmetric membrane with a thermally curable or UV curable polysiloxane or other suitable coating.

The membranes of the invention comprise a porous asymmetric membrane layer having a skin thickness of less than about 100 nm, preferably less than about 30 to 60 nm and most preferably between about 30 and 35 nm. These porous asymmetric membrane layers have a selectivity of at least 5 for separation of mixtures of CO₂/CH₄ at 50° C. and preferably a selectivity of at least 20 at 50° C.

The following examples are provided to illustrate one or more preferred embodiments of the invention, but are not limited embodiments thereof. Numerous variations can be made to the following examples that lie within the scope of the invention.

### Example 1

### A Cellulose Diacetate (CA) & Cellulose Triacetate (CTA) Asymmetric Membrane

A cellulose acetate/cellulose tracetate asymmetric membrane was prepared from a casting dope comprising, by approximate weight percentages, 8% cellulose triacetate, 8% cellulose diacetate, 32% 1,3 dioxolane, 12% NMP, 24% acetone, 12% methanol, 2% maleic acid and 3% n-decane. A film was cast on a nylon web, then gelled by immersion in a 0° C. water bath for about 10 minutes, and then annealed in a hot water bath at 86° C. for 10-15 minutes. The resulting wet membrane was dried at a temperature between 65° and 70° C. to remove water. The dry asymmetric cellulosic membrane was coated with an epoxy silicone solution containing 8 wt-% epoxy silicone solution. The silicone solvent contained a 1:3 ratio of hexane to heptane. The epoxy silicone coating was exposed to a UV source for a period of about 2 to 4 minutes at ambient temperature to cure the coating while the silicone solvent evaporated to produce the epoxy silicone coated membrane of the present invention.

The epoxy silicone coated membranes were evaluated for gas transport properties using a feed gas containing 10 vol-% CO₂ and 90 vol-% CH₄ at a feed pressure of 6.89 MPa (1000 psig) and 50° C. Table 1 shows a comparison of the CO₂ permeability and the selectivity (α) of the dense film (intrinsic properties) and the asymmetric membrane performances.

TABLE 1
Gas Transport Properties

| | | CO₂/CH₄ |
|---|---|---|
| Membrane | CO₂ | Selectivity |
| Dense film | 7.2 Barrers* | 21.9 |
| Asymmetric membrane | 136 (GPU**) | 17.3 |

*Barrer = 10⁻¹⁰ cm³(STP)cm/sec · cm³ · cmHg
**Gas Permeation Unit (GPU) = 10⁻⁶ cm³(STP)/cm²sec · cmHg

### Example 2

### Matrimid/Polyethersulfone Blended Asymmetric Membrane

A Matrimid polyimide/polyethersulfone blended asymmetric membrane was prepared from a casting dope comprising, by approximate weight percentages, 6.7% polyethersulfone, 11.8% Matrimid, 46.7% 1,3 dioxolane, 23.4% NMP, 5.8% acetone, and 5.8% methanol. A film was cast on a non-woven web then gelled by immersion in a 0° C. water bath for about 10 minutes, and then annealed in a hot water bath at 86° C. for 10-15 minutes. The resulting wet membrane was dried in at a temperature between 65° and 70° C. to remove water. The dry asymmetric membrane was coated with an epoxy silicone solution containing 8 wt-% epoxy silicone solution. The silicone solvent comprised a 1:3 ratio of hexane to heptane. The epoxy silicone coating was exposed to a UV source for a period of 2 to 4 minutes at ambient temperature to cure the coating while the silicone solvent evaporated to produce the epoxy silicone coated membrane of the present invention.

The epoxy silicone coated membranes were evaluated for gas transport properties using a feed gas containing 10 vol-% CO₂, 90 vol-% CH₄ at a feed pressure of 6.89 MPa (1000 psig) and 50° C. Table 2 shows a comparison of the CO₂ permeability and the selectivity (α) of the dense film (intrinsic properties) and the asymmetric membrane performances.

TABLE 2
Gas Transport Properties

| | | CO₂/CH₄ |
|---|---|---|
| Membrane | CO₂ | Selectivity |
| Dense film | 7.2 Barrers* | 25.1* |
| Asymmetric membrane | 110 GPU | 24.6 |

*Dense film was tested at 690 kPa (100 psig), 50° C. and pure gas

### Example 3

### P84 Polyimide/Polyethersulfone Blended Asymmetric Membrane

A P84 polyimide/polyethersulfone blended asymmetric membrane was prepared in from a casting dope comprising, by approximate weight percentages, 6.5% polyethersulfone, 12.2% P84 polyimide, 50.5% 1,3 dioxolane, 24.3% NMP, 3.7% acetone, and 2.8% methanol. A film was cast on a non-woven web, then gelled by immersion in a 0° C. water bath for about 10 minutes, and then annealed in a hot water bath at 86° C. for 10-15 minutes. The resulting wet membrane was dried at a temperature between 65° and 70° C. to remove water. The dry asymmetric membrane was coated with an epoxy silicone solution containing 8 wt-% epoxy silicone solution. The silicone solvent comprised a 1:3 ratio of hexane to heptane. The epoxy silicone coating was exposed to a UV source for a period of 2 to 4 minutes at ambient temperature to cure the coating while the silicone solvent evaporated to produce the epoxy silicone coated membrane of the present invention.

The epoxy silicone coated membranes were evaluated for gas transport properties using a feed gas containing 10 vol-% CO₂, 90 vol-% CH₄ at a feed pressure of 6.89 MPa (1000 psig) and 50° C. Table 3 shows a comparison of the CO₂ permeability and the selectivity (α) of the dense film (intrinsic properties) and the asymmetric membrane performances.

TABLE 3
Gas Transport Properties

| | | CO₂/CH₄ |
|---|---|---|
| Membrane | CO₂ | Selectivity |
| Dense film | 2.7 Barrers* | 33.7* |
| Asymmetric membrane | 39 GPU | 29.2 |

*Dense film was tested at 690 kPa (100 psig), 50° C. and pure gas

### Example 4

### P84HT Polyimide/Polyethersulfone Blended Asymmetric Membrane

A P84HT polyimide/polyethersulfone blended asymmetric membrane was prepared from a casting dope comprising, by approximate weight percentages, 6.4% polyethersulfone, 11.8% P84 polyimide, 49% 1,3 dioxolane, 24% NMP, 6.4% acetone, and 2.7% methanol. A film was cast on a non-woven web then gelled by immersion in a 0° C. water bath for about 10 minutes, and then annealed in a hot water bath at 86° C. for 10-15 minutes. The resulting wet membrane was dried in at a temperature between 65° and 70° C. to remove water. The dry asymmetric membrane was coated with an epoxy silicone solution containing 8 wt-% epoxy silicone solution. The silicone solvent comprised a 1:3 ratio of hexane to heptane. The epoxy silicone coating was exposed to a UV source for a period of 2 to 4 minutes at ambient temperature to cure the coating while the silicone solvent evaporated to produce the epoxy silicone coated membrane of the present invention.

The epoxy silicone coated membranes were evaluated for gas transport properties using a feed gas containing 10 vol-% CO₂, 90 vol-% CH₄ at a feed pressure of 6.89 MPa (1000 psig) and 50° C. Table 4 shows a comparison of the CO₂ permeability and the selectivity (α) of the dense film (intrinsic properties) and the asymmetric membrane performances.

TABLE 4
Gas Transport Properties

| | | CO₂/CH₄ |
|---|---|---|
| Membrane | CO₂ | Selectivity |
| Dense film | 3.8 Barrers* | 32.5* |
| Asymmetric membrane | 25 GPU | 30.0 |

*Dense film was tested at 690 kPa (100 psig), 50° C. and pure gas

### Example 5

### Ultem-1000 Polyetherimide Asymmetric Membrane

The Ultem-1000 polyetherimide asymmetric membrane was prepared from a casting dope comprising, by approximate weight percentages, 21% Ultem-1000, 55% 1, 3 dioxolane, 19% NMP, 3% acetone, and 2% methanol. A film was cast on a non-woven web then gelled by immersion in a 0° C. water bath for about 10 minutes, and then annealed in a hot water bath at 86° C. for 10-15 minutes. The resulting wet membrane was dried in at a temperature between 65° and 70° C. to remove water. The dry asymmetric membrane was coated with an epoxy silicone solution containing 8 wt-% epoxy silicone solution. The silicone solvent comprised a 1:3 ratio of hexane to heptane. The epoxy silicone coating was exposed to a UV source for a period of 2 to 4 minutes at ambient temperature to cure the coating while the silicone solvent evaporated to produce the epoxy silicone coated membrane of the present invention.

The epoxy silicone coated membranes were evaluated for gas transport properties using a feed gas containing 10 vol-% CO₂, 90 vol-% CH₄ at a feed pressure of 6.89 MPa (1000 psig) and 50° C. Table 5 shows a comparison of the CO₂ permeability and the selectivity (α) of the dense film (intrinsic properties) and the asymmetric membrane performances.

TABLE 5
Gas Transport Properties

| | | CO₂/CH₄ |
|---|---|---|
| Membrane | CO₂ | Selectivity |
| Dense film | 1.95 Barrers* | 30.3* |
| Asymmetric membrane | 28.5 GPU | 21.5 |

*Dense film was tested at 690 kPa (100 psig), 50° C. and pure gas

### Example 6

### Matrimid Polyimide Asymmetric Membrane

The Matrimid asymmetric membrane was prepared in a conventional manner from a casting dope comprising, by approximate weight percentages, 17% Matrimid, 51% 1,3 dioxolane, 20% NMP, 6% acetone, 6% methanol. A film was cast on a non-woven web then gelled by immersion in a 0° C. water bath for about 10 minutes, and then annealed in a hot water bath at 86° C. for 10-15 minutes. The resulting wet membrane was dried in at a temperature between 65° and 70° C. to remove water. The dry asymmetric membrane was coated with an epoxy silicone solution containing 8 wt-% epoxy silicone solution. The silicone solvent comprised a 1:3 ratio of hexane to heptane. The epoxy silicone coating was exposed to a UV source for a period of 2 to 4 minutes at ambient temperature to cure the coating while the silicone solvent evaporated to produce the epoxy silicone coated membrane of the present invention.

The epoxy silicone coated membranes were evaluated for gas transport properties using a feed gas containing 10 vol-% CO₂, 90 vol-% CH₄ at a feed pressure of 6.89 MPa (1000 psig) and 50° C. Table 6 shows a comparison of the CO₂ permeability and the selectivity (α) of the dense film (intrinsic properties) and the asymmetric membrane performances.

TABLE 6
Gas Transport Properties

| | | CO₂/CH₄ |
|---|---|---|
| Membrane | CO₂ | Selectivity |
| Dense film | 10.0 Barrers* | 28.2* |
| Asymmetric membrane | 140 GPU | 20.0 |

*Dense film was tested at 690 kPa (100 psig), 50° C. and pure gas

### Example 7

### P84 Polyimide Asymmetric Membrane

The P84 asymmetric membrane was prepared in a conventional manner from a casting dope comprising, by approximate weight percentages, 18.7% P84, 50.5% 1,3 dioxolane, 24.3% NMP, 3.7% acetone, and 2.8% methanol. A film was cast on a non-woven web then gelled by immersion in a 0° C. water bath for about 10 minutes, and then annealed in a hot water bath at 86° C. for 10-15 minutes. The resulting wet membrane was dried in at a temperature between 65° and 70° C. to remove water. The dry asymmetric membrane was coated with an epoxy silicone solution containing 8 wt-% epoxy silicone solution. The silicone solvent comprised a 1:3 ratio of hexane to heptane. The epoxy silicone coating was exposed to a UV source for a period of 2 to 4 minutes at ambient temperature to cure the coating while the silicone solvent evaporated to produce the epoxy silicone coated membrane of the present invention.

The epoxy silicone coated membranes were evaluated for gas transport properties using a feed gas containing 10 vol-% CO₂, 90 vol-% CH₄ at a feed pressure of 6.89 MPa (1000 psig) and 50° C. Table 7 shows a comparison of the CO₂ permeability and the selectivity (α) of the dense film (intrinsic properties) and the asymmetric membrane performances.

TABLE 7
Gas Transport Properties

| | CO₂ | CO₂/CH₄ |
|---|---|---|
| Membrane | Permeance | Selectivity |
| Dense film | 3.0 Barrers* | 28.0* |
| Asymmetric membrane | 8.7 GPU | 28.0 |

*Dense film was tested at 690 kPa (100 psig), 50° C. and pure gas

1. A method for making an asymmetric gas separation membrane, which method comprises:
forming a solution of at least one polymer, by dissolving said polymer in a solvent mixture of 1,3 dioxolane solvent and a second solvent wherein said casting solution contains a ratio of 1,3 dioxolane to said second solvent of from about 1 to 1 to about 99:1;
quenching the casting solution into a cold water gelation bath at a temperature between about 0° and 25° C.;
densifying the skin of a resulting asymmetric membrane in a warm water bath between about 25° and 100° C.; and
removing water from said asymmetric membrane to form a film comprising a skin thickness of less than about 100 nm.

2. The method of claim 1 wherein said skin thickness is between about 30 and 60 nm.

3. The method of claim 1 wherein said skin thickness is between about 30 and 35 nm.

4. The method of claim 1 wherein said asymmetric membrane has a selectivity for CO₂/CH₄ of at least 5 at 50° C.

5. The method of claim 1 wherein said asymmetric membrane has a selectivity for CO₂/CH₄ of at least 20 at 50° C.

6. The method of claim 1 wherein said second solvent is a solvent selected from the group consisting of N-methylpyrrolidone, N,N′-dimethylacetamide, or mixtures thereof.

7. The method of claim 1 wherein said second solvent is N,N′-methylpyrrolidinone.

8. The method of claim 1 wherein said at least one polymer is selected from the group consisting of polysulfones, sulfonated polysulfones; polyethersulfones, sulfonated polyethersulfones, polyethers, polyetherimides; poly(styrenes); styrene-containing copolymers selected from the group consisting of acrylonitrilestyrene copolymers, styrene-butadiene copolymers and styrene-vinylbenzylhalide copolymers; polycarbonates; cellulosic polymers selected from the group consisting of as cellulose acetate, cellulose triacetate, cellulose acetate-butyrate, cellulose propionate, ethyl cellulose, methyl cellulose, and nitrocellulose; polyamides; polyimides; polyamide/imides; polyketones, polyether ketones; poly(arylene oxides); poly(phenylene oxide) and poly(xylene oxide); poly(esteramide-diisocyanate); polyurethanes; polyesters; polysulfides; poly(ethylene), poly(propylene), poly(butene-1), poly(4-methyl pentene-1), polyvinyls, e.g., poly(vinyl chloride), poly(vinyl fluoride), poly(vinylidene chloride), poly(vinylidene fluoride), poly(vinyl alcohol), poly(vinyl esters); poly(vinyl acetate); poly(vinyl propionate), poly(vinyl pyridines), poly(vinyl pyrrolidones), poly(vinyl ethers), poly(vinyl ketones), poly(vinyl aldehydes); poly(vinyl formal); poly(vinyl butyral); poly(vinyl amides), poly(vinyl amines), poly(vinyl urethanes), poly(vinyl ureas), poly(vinyl phosphates), and poly(vinyl sulfates); polyallyls; poly(benzobenzimidazole); polyhydrazides; polyoxadiazoles; polytriazoles; poly(benzimidazole); polycarbodiimides; polyphosphazines; microporous polymers; interpolymers, block interpolymers containing repeating units from the above said polymers as terpolymers of acrylonitrile-vinyl bromide-sodium salt of para-sulfophenylmethallyl ethers; and grafts and blends of said polymers.

9. The method of claim 1 wherein said at least one polymer is selected from the group consisting of polysulfones, sulfonated polysulfones, polyethersulfones (PESs), sulfonated PESs, polyethers, polyetherimides, cellulosic polymers wherein said cellulosic polymers are cellulose acetate or cellulose triacetate; polyamides; polyimides, poly(3,3′,4,4′-benzophenone tetracarboxylic dianhydride-pyromellitic dianhydride-3,3′,5,5′-tetramethyl-4,4′-methylene dianiline) (poly(BTDA-PMDA-TMMDA)), poly(3,3′,4,4′-benzophenone tetracarboxylic dianhydride-pyromellitic dianhydride-4,4′-oxydiphthalic anhydride-3,3′,5,5′-tetramethyl-4,4′-methylene dianiline) (poly(BTDA-PMDA-ODPA-TMMDA)), poly(3,3′,4,4′-diphenylsulfone tetracarboxylic dianhydride-3,3′,5,5′-tetramethyl-4,4′-methylene dianiline) (poly(DSDA-TMMDA)), poly(3,3′,4,4′-benzophenone tetracarboxylic dianhydride-3,3′,5,5′-tetramethyl-4,4′-methylene dianiline) (poly(BTDA-TMMDA)), poly(3,3′,4,4′-diphenylsulfone tetracarboxylic dianhydride-pyromellitic dianhydride-3,3′,5,5′-tetramethyl-4,4′-methylene dianiline) (poly(DSDA-PMDA-TMMDA)), poly[2,2′-bis-(3,4-dicarboxyphenyl)hexafluoropropane dianhydride-1,3-phenylenediamine] (poly(6FDA-m-PDA)), poly[2,2′-bis-(3,4-dicarboxyphenyl)hexafluoropropane dianhydride-1,3-phenylenediamine-3,5-diaminobenzoic acid)] (poly(6FDA-m-PDA-DABA)), polyamide/imides mixtures; polyketones, polyether ketones; and microporous polymers.

10. The method of claim 1 wherein said at least one polymer is selected from the group consisting of polyethersulfones, polyimides, polyetherimides, polysulfones, cellulose acetate, cellulose triacetate, poly(vinyl alcohol)s, and microporous polymers.

11. The method of claim 1 wherein said solution further comprises at least one non-solvent selected from the group consisting of methanol, ethanol, isopropanol, acetone, methylethylketone, lactic acid, maleic acid, malic acid, decane, dodecane, nonane, and octane.

12. The method of claim 1 wherein said solution further comprises a non-solvent comprising a mixture of methanol and methylethylketone.

13. The method of claim 1 further comprising coating the surface of the membrane with a thermally curable or UV curable polysiloxane.

14. The method of claim 1 wherein said membrane is densified at a temperature between about 80° and 86° C.
